(19) United States
(12) Patent Application Publication
(10) Pub. No.: US 2015/0178250 A1
(43) Pub. Date: Jun. 25, 2015

(54) METHOD FOR DISPLAYING ELECTRONIC DOCUMENTS

(71) Applicant: Shun-Fu Technology Corp., Taipei City (TW)

(72) Inventor: Yung-Sheng HUANG, Taipei City (TW)

(21) Appl. No.: 14/540,252

(22) Filed: Nov. 13, 2014

(30) Foreign Application Priority Data
Dec. 25, 2013 (TW) 102148125

(51) Int. Cl. G06F 17/22; G06F 17/21

(52) U.S. Cl. CPC G06F 17/2241; G06F 17/212

(57) ABSTRACT

A method for displaying electronic documents is disclosed. The method includes the following steps: scanning reading data and converting the reading data to electronic documents having a format compatible to the electronic document reader; recognizing the electronic documents; capturing contents of the electronic documents and related diagrams, forms, chemical equations, mathematical equations, references and notes; and establishing indexes of the related diagrams, forms, chemical equations, mathematical equations, references and notes.

### BACKGROUND OF THE INVENTION

1. Field of the Invention

The invention relates to a method for displaying electronic documents, and more particularly to a method displaying texts, diagrams, forms, chemical equations, mathematical equations, references and notes related to electronic documents together in a area.

2. Description of the Related Art

Since environmental awareness is so emphasized, technologies of electronic documents for software or hardware are developed. As the electronic documents are displayed by E ink or typical display devices, no paper is needed. In addition, as electronic documents are digital data, user can read the electronic documents with an electronic document reader in which several electronic books are saved. This is very convenient for users.

Conventional electronic books often have files of continuous pages. When the electronic document reader reads an electronic book file, only one single page is displayed on the screen. Users are not needed to read the electronic book file by index, which is very convenient. The conventional electronic books are able to display a portion of the previous page and a portion of the next page on a screen simultaneously, whereby when a user is reading this page, he/she can recall the last several lines of the previous page or preview the top several lines of the next pages at the same time.

Although the conventional electronic books reduce visual fatigue caused by scrolling a document forwards and backwards, diagrams, forms, mathematical equations and chemical equations cannot displayed with texts on the same page. The user still needs to jump between the text page and the diagram page. The visual fatigue problem still exists.

### BRIEF SUMMARY OF THE INVENTION

The object of the invention is provides a method for displaying electronic documents, wherein indexes for related diagrams, forms, chemical equations, mathematical equations, references and notes are established by recognizing and sorting processes, and the related diagrams, forms, chemical equations, mathematical equations, references and notes are displayed in an area to facilitate reading.

To achieve the object, the invention provides a method for displaying electronic documents. The method in accordance with an exemplary embodiment of the invention includes scanning reading data and converting the reading data to electronic documents having a format compatible to the electronic document reader; recognizing the electronic documents; capturing contents of the electronic documents and related diagrams, forms, chemical equations, mathematical equations, references and notes; and establishing indexes of the related diagrams, forms, chemical equations, mathematical equations, references and notes.

In another exemplary embodiment, the method further includes establishing indexes of the related diagrams, forms, chemical equations, mathematical equations, references and notes.

In yet another exemplary embodiment, the related diagrams, forms, chemical equations, mathematical equations, references and notes are displayed in a floating area.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an electronic document reader of the invention;

FIG. 2 is a schematic view of a method for displaying electronic documents of the invention;

FIG. 3 is another schematic view of a method for displaying electronic documents of the invention;

FIG. 4 is another schematic view of a method for displaying electronic documents of the invention; and

FIG. 5 is a flow chart of a method for displaying electronic documents of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

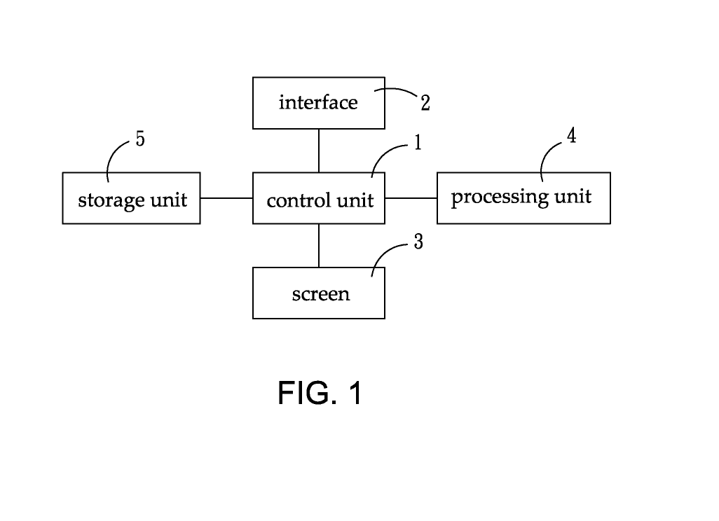

Referring to FIG. 1, an electronic document reader performing a method for displaying electronic documents is disclosed. The electronic document reader includes a control unit 1 electrically connected to an interface 2. A user can input information or operate the electronic document reader through the interface 2. The interface can be a keyboard or a touch interface. The control unit 1 is electrically connected to a screen 3. The screen 3 is configured to display the electronic book and to be utilized to operate the electronic document reader. The control unit 1 is further electrically connected to a processing unit 4. The processing unit 4 receives commands from the interface 2 to execute some programs for some operating processes saved in the processing unit 4. The control unit 1 is electrically connected to a storage unit 5. Data can be saved or temporarily saved in the storage unit 5. The electronic document reader can be all kinds of computer platform including computer, cell phone, tablet, E book, laptop, industrial computer etc.

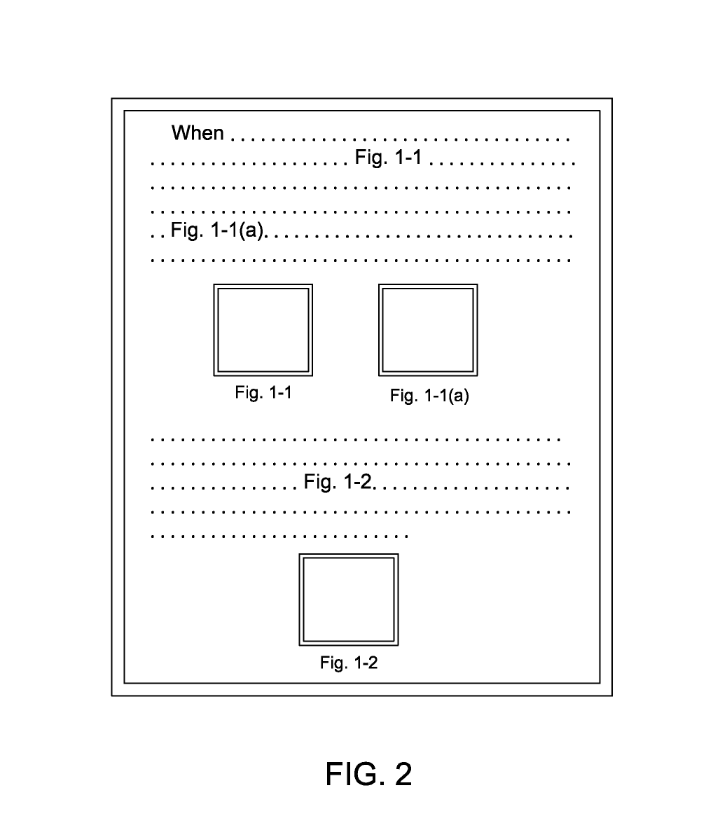

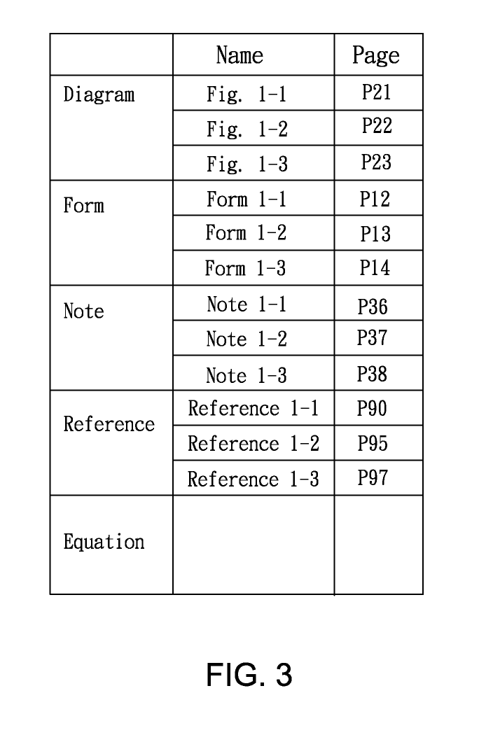

Referring to FIGS. 2 and 3, when a user is going to read information, he/she scans the information carried in an electronic document or paper and converts the information into an electronic document having a format compatible to the electronic document reader. The electronic document is saved in the storage unit 5. The processing unit 4 collects some information related to the electronic document. The programs saved in the processing unit 4 begins to recognize the electronic document and scan the electronic document including diagrams, forms, chemical equations, mathematical equations, references and notes corresponding to the text in the electronic document. The diagrams, forms, chemical equations, mathematical equations, references and notes are captured to establish indexes. FIG. 2 shows one page of the electronic document which includes text and diagrams including FIG. 1-1, FIG. 1-2 and FIG. 1-3 corresponding to the text. The FIG. 1-1 further includes small diagrams referred to FIG. 1-1(a), FIG. 1-1(b), FIG. 1-1(c). These diagrams are related but are different. The difference is also described in the text. The text of description and the diagrams are collected in a area. When the program in the processing unit 4 performs the recognizing process and sorting process, the indexes are established. As shown in FIG. 3, the programs in the processing unit 4 captures contents of the electronic documents and related diagrams, forms, chemical equations, mathematical equations, references and notes and establishes indexes, and collects related diagrams, forms, chemical equations, mathematical equations, references and notes in a form which can be displayed in the last portion of the electronic document or hidden in the electronic document reader. The format of the index is not limited to the format disclosed in this embodiment. The sorting process for forms, chemical equations, mathematical equations, references and notes is similar to the sorting process for diagrams.

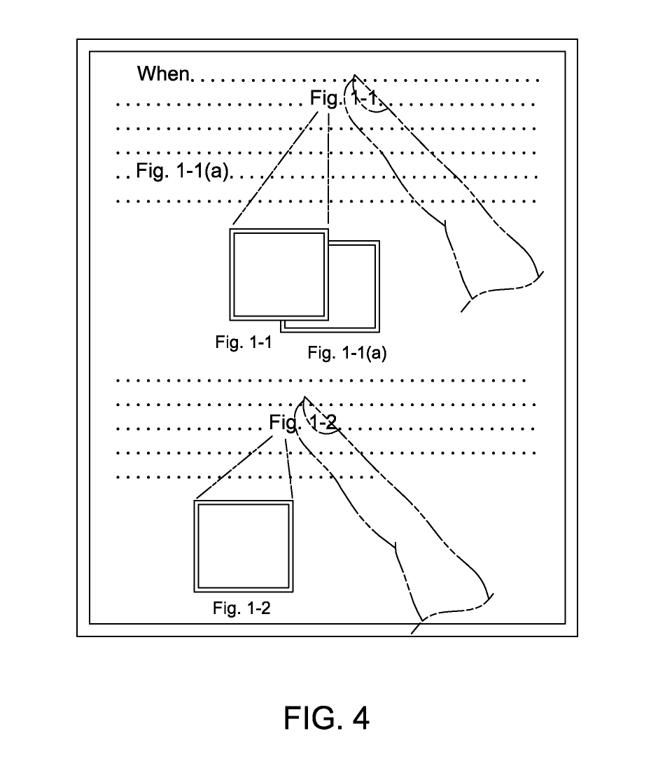

Referring to FIG. 4, when a user intends to read an electronic document using an electronic document reader, the user picks up contents through the interface 2 of the electronic document reader, and the processing unit 4 floatingly displays the FIG. 1-1 in a specific area shown in the same page contains the contents that the user intends to read. The floating specific area moves along with the user pulling or scrolling the page but do not blank the text not been read. The specific area can be enlarged or shrunken. The FIG. 1-1(a) is floating under the FIG. 1-1 for the user capable of reading them at the same time. The diagrams can be enlarged or shrunken through the interface 2. The operation for forms, chemical equations, mathematical equations, references and notes is similar to the operation for diagrams.

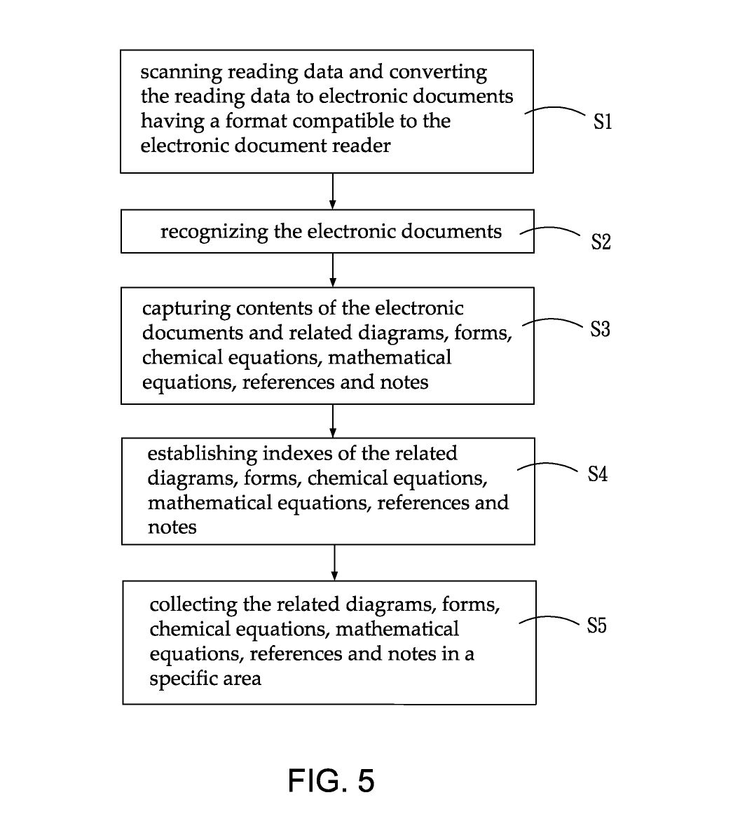

FIG. 5 is a flow chart of a method for displaying electronic documents of the invention. In step S1, reading data are scanned and converted to electronic documents having a format compatible to the electronic document reader. In step S2, the electronic documents are recognized. In step S3, contents of the electronic documents and related diagrams, forms, chemical equations, mathematical equations, references and notes are captured. In step S4, indexes of the related diagrams, forms, chemical equations, mathematical equations, references and notes are established. In step S5, the related diagrams, forms, chemical equations, mathematical equations, references and notes are collected in a specific area.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for displaying electronic documents performed in an electronic document reader, the method comprising:
scanning reading data and converting the reading data to electronic documents having a format compatible to the electronic document reader;
recognizing the electronic documents;
capturing contents of the electronic documents and related diagrams, forms, chemical equations, mathematical equations, references and notes; and
establishing indexes of the related diagrams, forms, chemical equations, mathematical equations, references and notes.

2. The method as claimed in claim 1 further comprising: collecting the related diagrams, forms, chemical equations, mathematical equations, references and notes in a specific area.

3. The method as claimed in claim 2, wherein the related diagrams, forms, chemical equations, mathematical equations, references and notes are floatingly displayed in the specific area.
